(19) United States
(12) Patent Application Publication
(10) Pub. No.: US 2026/0093907 A1
(43) Pub. Date: Apr. 2, 2026

(54) PROCESSING TABLES IN DOCUMENTS FOR PROMPT ANSWERING

(71) Applicant: Adobe Inc., San Jose, CA (US)

(72) Inventors: Surabhi Bhargava, San Jose, CA (US); Sruthi Ravi Madapoosi, San Jose, CA (US); Ruchi Rajiv Deshpande, Belmont, CA (US); Nedim Lipka, Campbell, CA (US); Emily Maeve Seminerio, Medfield, MA (US); Christopher Alan Tensmeyer, Fulton, MD (US); Ashutosh Mehra, Noida (IN); Apoorv Umang Saxena, Bangalore (IN); Alexander Cotton Glosband, Concord, MA (US); Aarushi Gupta, San Francisco, CA (US); Jayant Vaibhav Srivastava, Varanasi (IN)

(73) Assignee: Adobe Inc., San Jose, CA (US)

(21) Appl. No.: 18/902,220

(22) Filed: Sep. 30, 2024

(51) Int. Cl. G06F 40/177; G06F 16/332

(52) U.S. Cl. CPC G06F 40/177; G06F 16/3329

(57) ABSTRACT

In accordance with the described techniques, a processing device receives a document that includes a table, and a prompt pertaining to the document. The processing device is configured to detect, in the table, a row of column headers and a spanning cell that spans multiple rows or multiple columns in the table. In addition, the processing device modifies the table by inserting additional cells in the table and replicating cell content of the row of column headers and the spanning cell to the additional cells, resulting a modified table. Using a machine learning model, the processing device generates an answer to the prompt based on the document, in part, by extracting information from the modified table.

### BACKGROUND

Generative artificial intelligence (AI) improves efficiency for many content generation tasks. For example, prompt answering models often generate answers to questions or prompts by taking information from a variety of sources, summarizing and synthesizing the information, and providing an answer to the user in natural language. Thus, given an appropriate prompt, the prompt answering model is able to automatically generate textual content, such as emails, articles and blog posts, product descriptions, reports and summaries, social media posts, customer support responses, and so on.

### SUMMARY

A prompt answering pipeline is configured to receive a document that includes a table, and a prompt pertaining to the document. By way of example, the prompt is a question pertaining to the table in that answering the question involves extracting information from the table. Using a table structure detection model, the prompt answering pipeline detects a row of column headers and a spanning cell in the table. The row of column headers is a row of the table in which a threshold percentage of the cells are identified as column headers. The spanning cell is a cell that spans multiple rows and/or multiple columns in the table. In accordance with the described techniques, the prompt answering pipeline modifies the table by inserting one or more additional rows in between rows of the table positioned beneath the row of column headers, and replicating the row of column headers to the one or more additional rows. Additionally or alternatively, the prompt answering pipeline modifies the table by splitting the spanning cell into multiple cells, and replicating cell content of the spanning cell to the multiple cells. Using a machine learning model, the prompt answering pipeline generates an answer to the prompt, in part, by extracting information from the modified table.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of an environment in an example implementation that is operable to employ techniques described herein for processing tables in documents for prompt answering.

FIG. 2 depicts a system in an example implementation showing operation of a prompt answering pipeline to process a document that includes a table for prompt answering by a prompt answering model.

FIG. 3 depicts an example of table modification for prompt answering in accordance with the techniques discussed herein.

FIG. 4 depicts an example of document chunking for prompt answering in accordance with techniques discussed herein

FIG. 5 depicts a system in an example implementation showing operation of an embedding model to index a plurality of chunks of a document as a plurality of embeddings for prompt answering.

FIG. 6 is a flow diagram depicting a procedure in an example implementation for processing tables in documents for prompt answering.

FIG. 7 is a flow diagram depicting a procedure in an example implementation for processing tables in documents for prompt answering.

FIG. 8 illustrates an example system including various components of an example device that can be implemented as any type of computing device as described and/or utilized with reference to FIGS. 1-7 to implement embodiments of the techniques described herein.

### DETAILED DESCRIPTION

### Overview

Prompt answering models are machine learning models configured to receive a prompt as input, and generate a natural language answer to the prompt. In various scenarios, prompt answering models are additionally provided a document, and instructed to answer the prompt by synthesizing and summarizing information from the document. Oftentimes, the document includes a table, and accurate answering of the prompt involves extracting, summarizing, and/or synthesizing information from the table. Conventional prompt answering techniques, however, often struggle to comprehend intra-table relationships conveyed by table structure, e.g., which row and which column a particular cell of the table belongs to. Due to this, conventional prompt answering techniques often answer table-specific prompts inaccurately, and/or incorrectly conclude that table-specific prompts are not supported by the document.

To overcome these limitations, techniques for processing tables in documents for prompt answering are discussed herein as implemented by a prompt answering pipeline. In accordance with the described techniques, a prompt answering pipeline receives a document that includes a table, and a prompt pertaining to the document. More specifically, the prompt pertains to the table in that accurate answering of the prompt involves extracting information from the table.

The prompt answering pipeline includes a table structure detection model, which is a machine learning model that has been trained to detect a plurality of structural elements in tables. Here, the table structure detection model processes the table to detect structural elements of the table, such as rows, columns, individual cells, header cells (e.g., column headers and row headers), spanning cells, and the like. In particular, the table structure detection model detects a row of column headers, which is a row of the table in which at least a threshold percentage of cells are detected as column headers. Notably, a column header is a cell of a column that provides contextual information for cells in the column positioned beneath the column header. Additionally, the table structure detection model detects a spanning cell, which is a cell that spans multiple rows and/or multiple columns of the table.

In one or more implementations, the prompt answering pipeline is configured to modify the table. As part of this, the prompt answering pipeline inserts one or more additional rows in between one or more rows of the table positioned beneath the row of column headers. In addition, the prompt answering pipeline replicates the row of column headers to the one or more additional rows. Moreover, the prompt answering pipeline splits the spanning cell into multiple split cells based on a number of rows and/or columns that the spanning cell spans, and the prompt answering pipeline replicates cell content of the spanning cell to the multiple split cells. The modified table is additionally encoded in a format (e.g., hypertext markup language (HTML)) that differs from non-table content in the document.

In implementations, the prompt answering model is configured to split the document having the modified table into a plurality of chunks. In particular, the prompt answering model applies various table-specific chunking techniques to improve answer accuracy and relevancy for table-specific prompts.

One such chunking technique includes incorporating the modified table into chunks that are a smaller size than chunks that do not include content of the modified table. For example, the document is split into one or more table chunks that include content of the modified table, as well as one or more non-table chunks that do not include any content of the modified table. Further, the prompt answering pipeline confines the table chunks to a first threshold size and confines the non-table chunks to a second threshold size, such that the first threshold size is smaller than the second threshold size. For example, the prompt answering pipeline is configured to include fewer than a first threshold number of tokens (e.g., 6,000 tokens) in the table chunks, and include fewer than a second threshold number of tokens (e.g., 16,000 tokens) in the non-table chunks. As part of this, the prompt answering pipeline is configured to avoid splitting the modified table into multiple chunks if the modified table fits within a table chunk that is less than or equal to the first threshold size.

Another chunking technique includes replicating a document header to all chunks having content that falls under the document header. A document header, for instance, is a heading in the document that provides contextual information for content of the document that falls under the document header. Content of the document is considered to fall under a document header if the content is after the document header in reading order, and before a subsequent document header in reading order. Here, for example, the document is split such that a set of chunks included content that falls under a document header, and as such, the document header is replicated to each chunk in the set of chunks. In situations in which one or more chunks fall under multiple document headers (e.g., a document header and a document sub-header that falls under the document sub-header), the multiple document headers are replicated to the one or more chunks.

Another chunking technique includes replicating non-table data that is pertinent to the modified table to each table chunk representing the modified table. In situations in which the modified table does not fit within a table chunk that is less than or equal to the first threshold size, the prompt answering pipeline splits the modified table into multiple table chunks. Here, the prompt answering pipeline is configured to replicate a table caption of the modified table to each of the multiple table chunks. The table caption is a portion of text in the document (e.g., typically situated immediately after the table in the document in reading order) providing contextual information about the table and/or summarizing findings from the table. In addition, the prompt answering model is configured to replicate a predefined amount of textual content occurring immediately prior to the table in the document (in reading order) to the multiple table chunks. For example, the prompt answering model replicates, to each of the multiple table chunks, two sentences of long form textual content (e.g., natural language paragraphs, and not document headers, images, figures, lists, table captions, and the like) occurring immediately before the modified table in reading order.

In accordance with the described techniques, the plurality of chunks are provided to a prompt answering model along with the prompt. The prompt answering model, for example, is a large language model (LLM) (e.g., a generative pre-trained transformer model) pre-trained to perform a variety of natural language processing tasks, including question/prompt answering. Accordingly, the prompt answering model generates an answer to the prompt by processing the plurality of chunks, and extracting information from the modified table.

The described table modification techniques improve answer accuracy and relevancy over conventional techniques. Indeed, conventional prompt answering techniques often fail to recognize a row of column headers as being applicable to rows that are positionally further (e.g., more rows away) from the row of column headers. Thus, by replicating the row of column headers in the described manner, the described techniques enable the prompt answering model to consistently apply the context of the row of column headers to other rows that the row of column headers provides context for. Unlike conventional techniques, the described techniques treat a spanning cell as multiple individual cells which reduces table complexity, absolves the prompt answering model of interpreting information conveyed by the span of the spanning cell, and enables the prompt answering model to better apply the information conveyed by a spanning cell.

The described table chunking techniques additionally improve answer accuracy and relevancy over conventional techniques. Indeed, conventional prompt answering techniques often fail to identify an answer to the prompt within large chunks (or within the document in its entirety) when the answer is present in the table. This is referred to as a “lost in the middle” phenomenon. By incorporating tables into smaller document chunks than non-table data, the prompt answering model is able to focus on the table data in a more localized manner, thereby reducing “lost in the middle” scenarios and improving answer accuracy and relevancy with respect to table-specific prompts. Various other chunking strategies discussed herein are applicable replicate content (e.g., document headers, table captions, long form text) to multiple chunks that the content applies to, thereby increasing context retention across chunks and improving answer accuracy and relevancy.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Environment

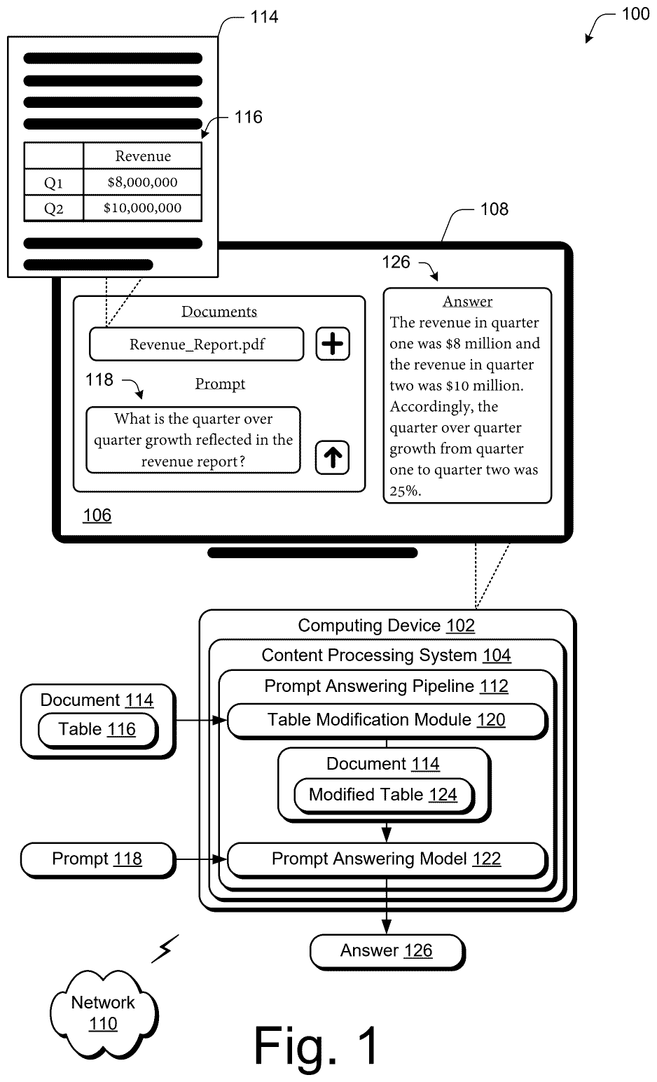

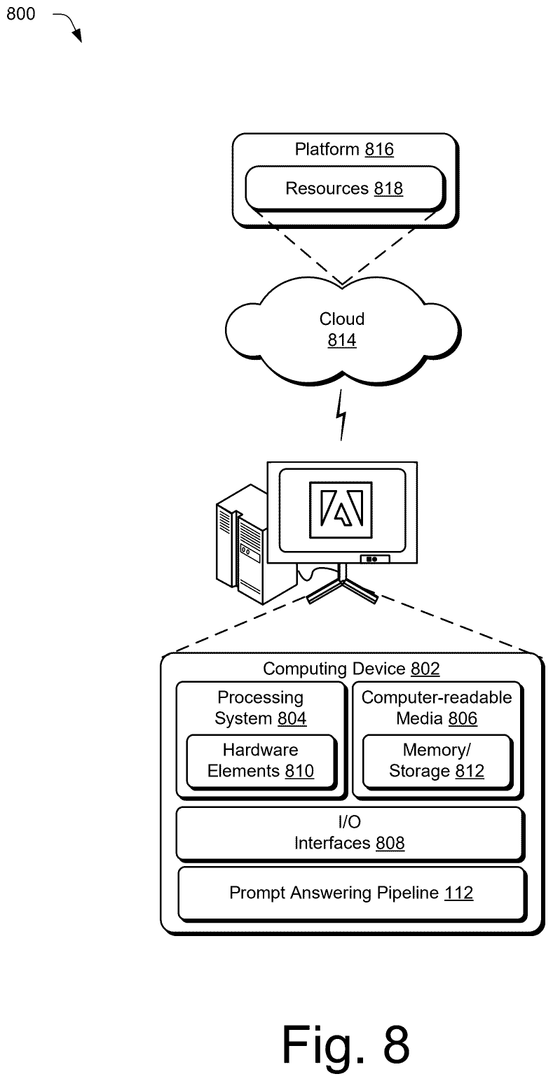

FIG. 1 is an illustration of an environment 100 in an example implementation that is operable to employ techniques described herein for processing tables in documents for prompt answering. The illustrated environment 100 includes a computing device 102, which is configurable in a variety of ways. The computing device 102, for instance, is configurable as a desktop computer, a laptop computer, a mobile device (e.g., assuming a handheld configuration such as a tablet or mobile phone as illustrated), and so forth. Thus, the computing device 102 ranges from full resource devices with substantial memory and processor resources (e.g., personal computers, game consoles) to a low-resource device with limited memory and/or processing resources (e.g., mobile devices). Additionally, although a single computing device 102 is shown, the computing device 102 is also representative of a plurality of different devices, such as multiple servers utilized by a business to perform operations “over the cloud” as described in FIG. 8.

The computing device 102 is illustrated as including a content processing system 104. The content processing system 104 is implemented at least partially in hardware of the computing device 102 to process and transform digital content. Such processing includes creation of the digital content, modification of the digital content, and rendering of the digital content in a user interface 106 for output, e.g., by a display device 108. Although illustrated as implemented locally at the computing device 102, functionality of the content processing system 104 is also configurable as whole or part via functionality available via the network 110, such as part of a web service or “in the cloud.”

An example of functionality incorporated by the content processing system 104 to process the digital content is illustrated as a prompt answering pipeline 112. As shown, the prompt answering pipeline 112 receives, as input, a document 114 that includes a table 116. The table 116, for instance, is a structure in the document 114 that is organized into rows and columns of a grid, such that content (e.g., letters, numbers, symbols, or other characters) is placed within individual cells of the grid. In addition, the prompt answering pipeline 112 receives, as input, a prompt 118 pertaining to the document 114. For example, the prompt 118 is a question pertaining to the table 116 in that accurately answering the question involves extracting, summarizing, and/or synthesizing information from the table 116 in the document 114, as shown in the illustrated example.

As shown, the document 114 is provided as input to a table modification module 120, which is representative of functionality for modifying and/or preprocessing the table 116 to enable a prompt answering model 122 to better understand meaning and relationships conveyed by the structure of the table 116. In one example, the prompt answering pipeline 112 detects a row of column headers in the table 116, e.g., a row having multiple header cells that provide context with respect to the cells that are beneath the header cells. In this example, the table modification module 120 inserts additional rows in between the rows of the table 116 that are positioned beneath the row of column headers, and replicates the row of column headers to the additional rows. In another example, the prompt answering pipeline 112 detects a spanning cell in the table 116, e.g., a cell that spans multiple rows and/or multiple columns in the table 116. In this example, the table modification module 120 splits the spanning cell into multiple cells, and replicates cell content of the spanning cell to each of the multiple cells.

Once the table 116 is modified, the document 114 (including the modified table 124) is provided to the prompt answering model 122 along with the prompt 118. In one or more implementations, the prompt answering model 122 is a large language model (LLM) (e.g., a generative pre-trained transformer (GPT) model) pre-trained to perform a variety of natural language processing tasks, including question/prompt answering. Here, the prompt answering model 122 generates an answer 126 to the prompt 118, in part, by extracting information from the modified table 124. As shown in the illustrated example, for instance, the prompt answering model 122 generates an answer 126 to the prompt 118 by extracting, summarizing, and performing arithmetic operations on information present in the cells of the table 116.

Conventional prompt answering techniques often face difficulties answering prompts that pertain to tables in documents. This is due to the structure based complexity present in tables that is not present in natural language text. Indeed, important context regarding the content of an individual cell can be gleaned from which column the individual cell belongs to, which row the individual cell belongs to, which headers the individual cell falls under, etc. In particular, LLMs often struggle to apply the context of column headers when interpreting cells that are positionally further from (e.g., many rows beneath) the column headers. Thus, by replicating the row of column headers in the manner described, the described techniques improve retention of column header context across the cells that column headers provide context for, resulting in improved answer accuracy and relevancy. In addition, the described techniques treat a spanning cell as multiple individual cells, which reduces table complexity by absolving the prompt answering model 122 of interpreting information conveyed by the span of the spanning cell, thereby improving answer accuracy and relevancy.

### Table Based Prompt Answering Features

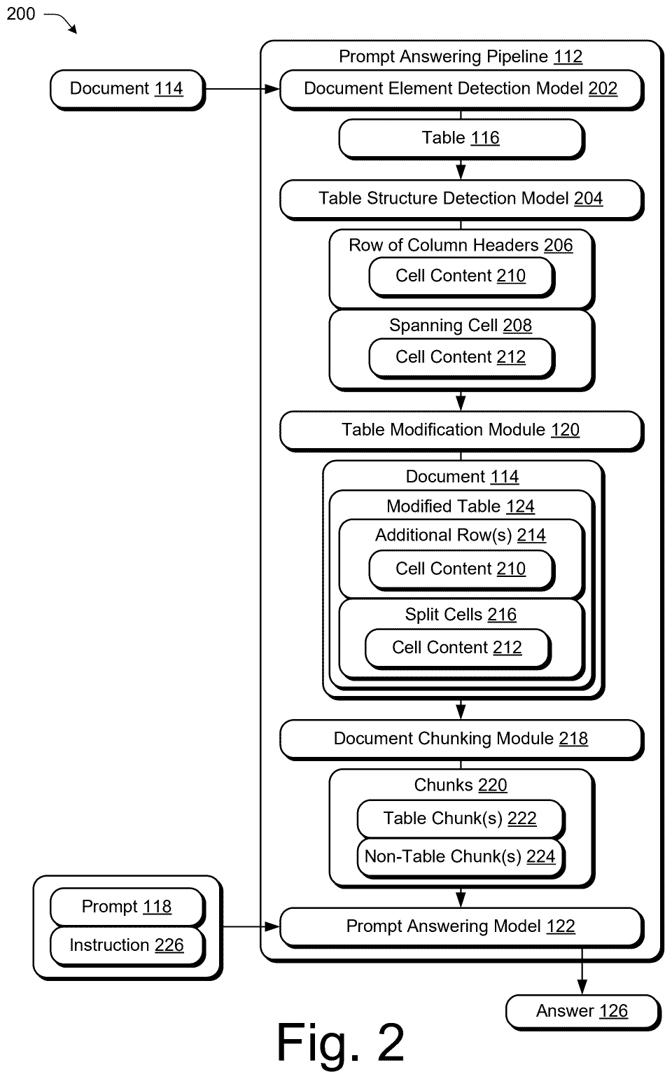

FIG. 2 depicts a system 200 in an example implementation showing operation of a prompt answering pipeline to process a document that includes a table for prompt answering by a prompt answering model. As shown, a document element detection model 202 receives the document 114, which in one or more examples is a portable document format (PDF) document. The document element detection model 202 is a machine learning model (e.g., an object detection model) that has been trained to detect a plurality of document elements in an input document. Examples of the document elements include tables, paragraphs, images, figures, lists, footnotes, and document headings. Any one or more of a variety of public or proprietary object detection models are implementable as the document element detection model 202, one example of which is a DocExtractor model.

As used herein, the term “machine learning model” refers to a computer representation that is tunable (e.g., trainable) based on inputs to approximate unknown functions. By way of example, the term “machine learning model” includes a model that utilizes algorithms to learn from, and make predictions on, known data by analyzing the known data to learn to generate outputs that reflect patterns and attributes of the known data. According to various implementations, such a machine learning model uses supervised learning, semi-supervised learning, unsupervised learning, reinforcement learning, continuous learning, interactive learning, and/or transfer learning. For example, a machine learning model is capable of including, but is not limited to including, clustering, decision trees, support vector machines, linear regression, logistic regression, Bayesian networks, random forest learning, dimensionality reduction algorithms, boosting algorithms, artificial neural networks (e.g., fully-connected neural networks, deep convolutional neural networks, or recurrent neural networks), deep learning, etc.

In one or more implementations, the document element detection model 202 is trained using supervised learning. In particular, the document element detection model 202 is trained on a training dataset that includes training documents and labels identifying ground truth document elements (e.g., tables, paragraphs, figures, lists, footnotes, headings, etc.) in the training documents. To train the model, the document element detection model 202 is leveraged to detect predicted document elements in a training document. Further, the ground truth document elements are compared to the predicted document elements to generate a loss, e.g., using a loss function. For example, the loss increases in correlation with a number of missed document elements (e.g., ground truth document elements that are not detected by the model) and a number of wrongly classified document elements, e.g., a table that is incorrectly classified as a list. Moreover, parameters (e.g., internal weights) of the document element detection model 202 are updated to reduce the loss. This process is repeated on different training samples of the training dataset until the loss converges to a minimum, a threshold number of iterations have completed, or a threshold number of epochs have been processed.

As shown, the trained document element detection model 202 receives the document 114 as input, and detects the table 116 as output. Although only the table 116 is depicted as being detected by the document element detection model 202 in the illustrated example, the document element detection model 202 detects more than one table 116 and a plurality of other document elements (e.g., paragraphs, figures, lists, footnotes, and headings). Moreover, while example operations are described herein with respect to a single table 116 and/or a single modified table 124 of the document 114, it is to be appreciated that similar operations are performable on multiple tables 116 and/or multiple modified tables 124 of the document 114.

In one or more implementations, the table 116 is provided as input to a table structure detection model 204, which is a machine learning model (e.g., an object detection model) that has been trained to detect a plurality of structural elements of tables. Example structural elements include rows, columns, individual cells, header cells (e.g., column headers and row headers), spanning cells, and the like. Any one or more of a variety of public or proprietary object detection models are implementable as the table structure detection model 204, one example of which is a TabNet model.

In one or more implementations, the table structure detection model 204 is trained using machine learning. In particular, the table structure detection model 204 is trained on a training dataset that includes training tables and labels identifying identify ground truth structural elements (e.g., rows, columns, cells, spanning cells, column headers, and row headers) in the training tables. To train the model, the table structure detection model 204 is leveraged to detect predicted structural elements in a training table. Further, the ground truth structural elements are compared to the predicted structural elements to generate a loss, e.g., using a loss function. For example, the loss increases in correlation with a number of missed structural elements (e.g., ground truth structural elements that are not detected by the model) and a number of wrongly classified structural elements, e.g., a spanning cell that is incorrectly identified as a non-spanning cell, e.g., a cell that spans one column and one row. Moreover, parameters (e.g., internal weights) of the table structure detection model 204 are updated to reduce the loss. This process is repeated on different training samples of the training dataset until the loss converges to a minimum, a threshold number of iterations have completed, or a threshold number of epochs have been processed.

Here, the trained table structure detection model 204 receives the table 116 as input, and detects a plurality of structural elements of the table 116 as output, e.g., rows, columns, non-spanning cells, spanning cells, column headers, and column headers. In particular, the table structure detection model 204 detects a row of column headers 206 and a spanning cell 208. Broadly, the row of column headers 206 is a row detected in the table 116, in which all cells in the row (or at least a threshold percentage of cells in the row) are detected as column headers. Notably, a column header is a cell in a column of the table 116 (e.g., typically situated at or near the top of the table 116) that provides contextual information for cells in the column that are positioned beneath the column header. Furthermore, a spanning cell 208 is a cell in the table that spans multiple rows and/or multiple columns in the table 116.

In one or more implementations, the prompt answering pipeline 112 performs optical character recognition on the document 114 to identify text (e.g., letters, numbers, symbols, or other characters) in the document 114. Particularly, with respect to the table 116, if text is detected within a cell of the table 116, the prompt answering pipeline 112 assigns the detected text to the cell. As a result, the row of column headers 206 include cell content 210 (e.g., text) detected within individual cells of the row of column headers 206, and the spanning cell 208 includes cell content 212 (e.g., text) detected within the spanning cell 208.

As shown, the row of column headers 206 and the spanning cell 208 are provided as input to the table modification module 120, which modifies the table 116 to generate a modified table 124. In particular, the table modification module 120 encodes the modified table 124 in a format that differs from the other document elements, e.g., paragraphs, images, figures, lists, footnotes, and document headings. In one or more examples, the modified table 124 is encoded in a hypertext markup language (HTML) format, while other document elements of the document are not encoded in HTML format. By formatting tables 116 differently from non-table content in the document 114, the described techniques enable the prompt answering model 122 to differentiate table content from non-table content.

As shown, the table modification module 120 inserts one or more additional rows 214 in between rows of the table 116 that are positioned beneath the row of column headers 206 in the table 116, and replicates the cell content 210 of the row of column headers 206 to the one or more additional rows 214. Furthermore, the table modification module 120 splits the spanning cell 208 into a number of split cells 216. In particular, the number of split cells 216 is obtained by multiplying a number of columns that the spanning cell 208 spans by a number of rows that the spanning cell 208 spans. In an example in which the spanning cell 208 occupies three rows and two columns, therefore, the number of split cells 216 is six. Moreover, the table modification module 120 replicates the cell content 212 of the spanning cell 208 to the split cells 216.

In one or more implementations, the table structure detection model 204 detects multiple rows of column headers 206. In one example, the table structure detection model 204 detects, in the table 116, a first row of column headers 206, first rows of non-header content positioned beneath the first row of column headers 206, a second row of column headers 206 positioned beneath the first rows, and second rows of non-header content positioned beneath the second row of column headers, e.g., at least one row of non-header content is positioned between the rows of column headers 206. In this example, the table modification module 120 inserts one additional row 214 in between each of the first rows of non-header content, and replicates the cell content 210 of the first row of column headers 206 to the additional rows 214 inserted between each of the first rows. Furthermore, the table modification module 120 inserts one additional row 214 in between each of the second rows of non-header content, and replicates the cell content 210 of the second row of column headers 206 to the additional rows 214 inserted in between each of the second rows.

In another example, the table structure model 204 detects, in the table 116, a first row of column headers 206, a second row of column headers 206 positioned beneath the first row of column headers 206, and rows of non-header content positioned beneath the second row of column headers 206, e.g., multiple rows of column headers 206 are stacked directly on top of one another. In this example, the table modification module 120 inserts two additional rows 214 in between each of the rows of non-header content, and replicates the cell content 210 of the first row of column headers 206 and the second row of column headers 206 to the two additional rows.

In one or more implementations, multiple spanning cells 208 are detected in the table 116 by the table structure detection model 204. In these scenarios, the table modification module 120 modifies each of the spanning cells 208 in the manner described. For each detected spanning cell 208, for instance, the table modification module 120 splits the spanning cell 208 into multiple split cells 216, and replicates the cell content 212 of the spanning cell 208 to the multiple split cells 216.

Notably, various examples are described herein in which additional rows are inserted into the table 116, and cell content of the row of column headers 206 is replicated to the additional rows. It is to be appreciated, however, that similar replication operations are additionally or alternatively performable with respect to a column of row headers detected in the table 116. For example, a column of row headers is a column detected in the table 116, in which all cells in the column (or at least a threshold percentage of cells in the column) are detected as row headers. A row header is a cell in a row of the table 116 that provides contextual information for cells in the row that are positioned laterally (e.g., to the left and/or to the right) with respect to the row header. Given this, the table modification module 120 inserts one or more additional columns in between columns of the table 116 that are positioned laterally with respect to the column of row headers, and replicates the cell content of the column of row headers to the one or more additional columns.

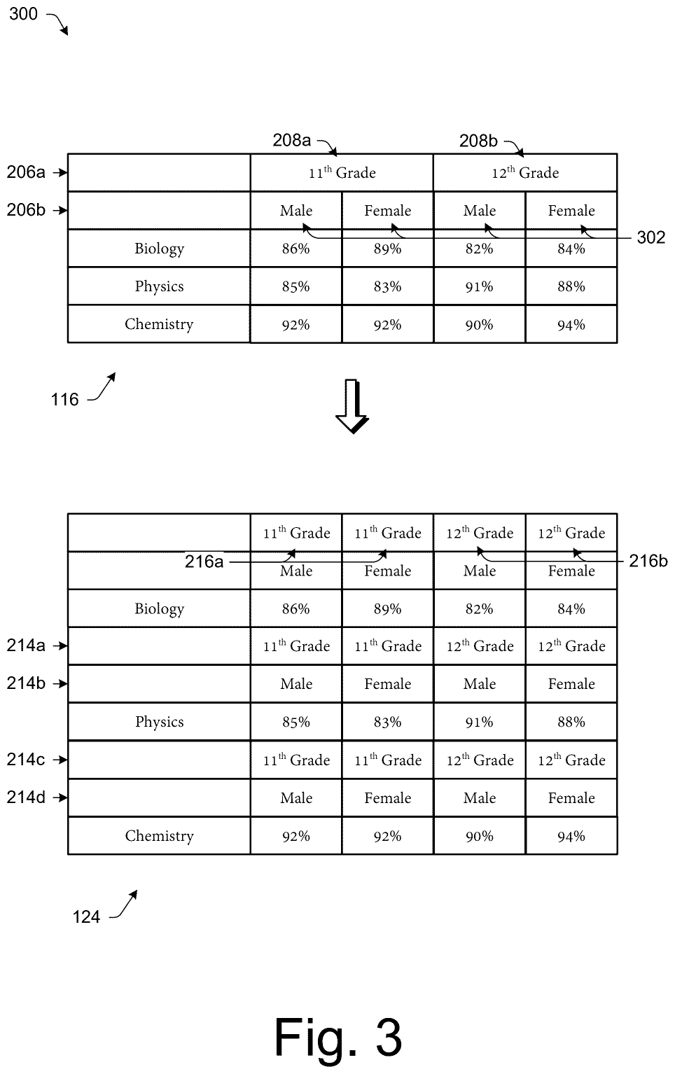

FIG. 3 depicts an example 300 of table modification for prompt answering in accordance with the techniques discussed herein. The example 300 includes the table 116 and the modified table 124. Here, the table structure detection model 204 identifies spanning cells 208a, 208b in the table 116 because the spanning cells 208a, 208b span two columns. In addition, the table structure detection model 204 identifies the spanning cells 208a, 208b and cells 302 as column headers. Accordingly, the table structure detection model 204 identifies rows of column headers 206a, 206b because more than a threshold percentage (e.g., fifty percent) of the cells in the rows are identified as column headers.

As shown in the modified table 124, the table modification module 120 splits the spanning cell 208a into multiple split cells 216a, and replicates cell content of the spanning cell 208a (e.g., “11^{th} grade”) to the multiple split cells 216a. Similarly, the table modification module 120 splits the spanning cell 208b into multiple split cells 216b, and replicates cell content of the spanning cell 208b (e.g., “12^{th} grade”) to the multiple split cells 216b.

Furthermore, the table modification module 120 inserts additional rows 214a, 214b, 214c, 214d in between the original rows of the table 116. As shown, the table modification module 120 copies the cell content of the row of column headers 206a (including the multiple split cells 216a, 216b having the replicated spanning cell content) to the additional rows 214a, 214c. Moreover, the table modification module 120 copies the cell content of the row of column headers 206b to the additional rows 214b, 214d.

Thus, when a row of column headers 206 also includes a spanning cell 208, the spanning cell 208 is first split into multiple split cells 216 and cell content 212 of the spanning cell 208 is replicated to the multiple split cells 216, in accordance with the described techniques. Thereafter, the row of column headers 206 (including the multiple split cells 216 with the replicated spanning cell content) is replicated to the additional rows 214, in accordance with the described techniques.

In the example 400, the table 116 includes the rows of column headers 206a, 206b and three rows positioned beneath the rows of column headers 206a, 206b. Given this, the process of replicating the rows of column headers 206a, 206b to the additional rows 214 is conceptualizable as generating a modified table 124 by creating and concatenating multiple tables. In this example, each of the multiple tables have the rows of column headers 206a, 206b and a different one of the three rows positioned beneath rows of column headers 206a, 206b.

By positioning column headers positionally closer to the cells that the column headers provide contextual information for, the described techniques enable the prompt answering model 122 to consistently retain the context provided by the column headers when interpreting the cells beneath the column headers. This is true regardless of how many rows beneath the column headers a particular cell is originally positioned in the table 116. Moreover, the process of splitting spanning cells 208 and replicating the spanning cell content to the split cells 216 removes the complexity and computational overhead associated with interpreting information conveyed by the span of a spanning cell by the prompt answering model 122.

It should be noted that the table 116 and the modified table are depicted in an unencoded form (e.g., not encoded in an HTML format) for illustrative purposes. However, it is to be appreciated that, in one or more implementations, the table 116 is first encoded in HTML format, and thereafter, table modifications are made in HTML format to generate the modified table 124 in HTML format.

Returning to FIG. 2, the document 114 having the modified table 124 is provided as input to a document chunking module 218. Broadly, the document chunking module 218 splits the document 114 into a plurality of chunks 220, and provides the chunks 220 as input for processing by the prompt answering model 122. Generally, document chunking enables numerous computational and practical advantages for the prompt answering model 122. In particular, breaking the document 114 into smaller individually processable chunks 220 avoids overwhelming the prompt answering model 122 with a large document, thereby reducing prompt answering latency while reducing the risk of resource constraints. Moreover, the smaller document chunks 220 enable the prompt answering model 122 to focus on more localized information, thereby producing more accurate and relevant answers in various implementation scenarios.

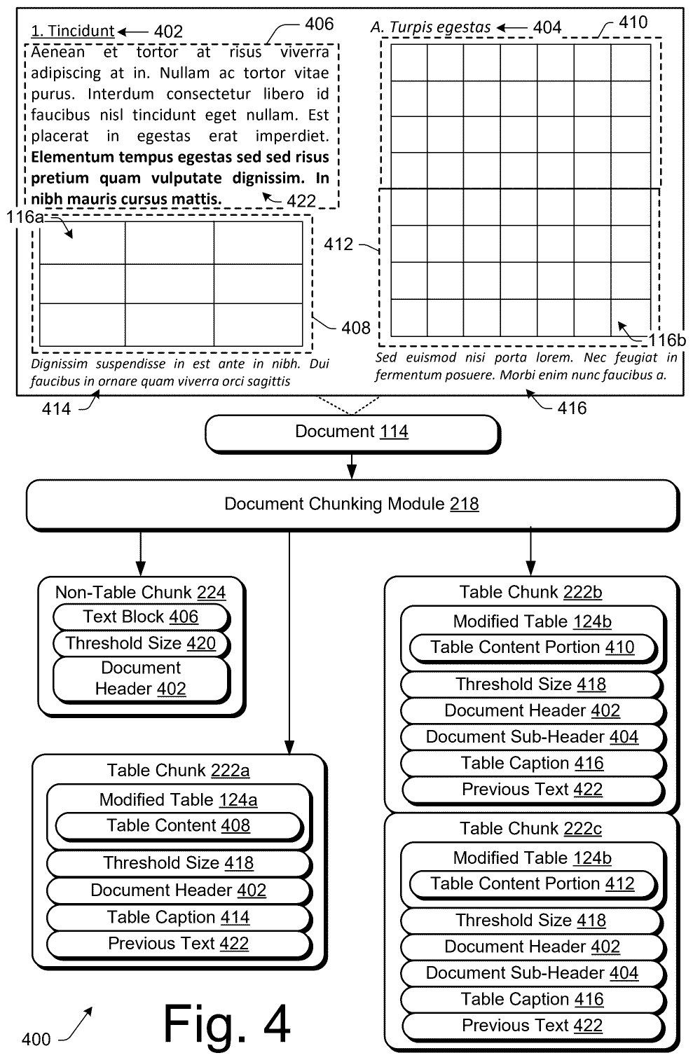

Here, the document chunking module 218 implements various table-specific document chunking techniques that improve answer accuracy and relevancy with respect to answering table-specific prompts, as discussed in more detail below with reference to FIG. 4. One such technique involves splitting the document 114 into table chunks 222 (e.g., chunks that include at least one modified table 124) and non-table chunks 224, e.g., chunks that exclude content of any modified tables 124. For example, the document chunking module 218 generates one or more table chunks 222 including content of the modified table 124, and one or more non-table chunks 224 excluding content of the modified table 124.

In one or more implementations, the document chunking module 218 confines the table chunks 222 to a first threshold size, and confines non-table chunks 224 to a second threshold size, such that the first maximum size is smaller than the second maximum size. For example, the document chunking module 218 is configured to include fewer than or equal to a first threshold number of tokens (e.g., 6,000 tokens) in table chunks 222, and the document chunking module 218 is configured to include fewer than or equal to a second threshold number of tokens (e.g., 16,000 tokens) in non-table chunks 224. Notably, tokens are units of text in the document 114, such that different tokens correspond to individual words, individual numbers, individual punctuation marks, and/or other textual elements in the document 114. Although examples are described herein in which the first threshold number of tokens is 6,000 and the second threshold number of tokens is 16,000, these numbers are not to be construed as limiting, and other numbers of token thresholds are considered.

FIG. 4 depicts an example 400 of document chunking for prompt answering in accordance with techniques discussed herein. As shown, the example 400 includes the document 114 having a document header 402 and a document sub-header 404 detected by the table structure detection model 204. By way of example, the table structure detection model 204 includes functionality for distinguishing between document headers and document sub-headers based on various text-based indicators, such as outlining/listing schemes, font characteristics, and the like.

Here, for example, the table structure detection model 204 detects the document header 402 and the document sub-header 404 based on an outlining scheme in which numbers (e.g., 1, 2, 3, 4) identify document headers and letters (A, B, C, D) identify document sub-headers. Additionally or alternatively, the table structure detection model 204 detects the document header 402 and the document sub-header 404 based on font characteristics indicating that underlined text identifies document headers, and italicized text identifies document sub-headers.

Furthermore, various content is depicted as “falling under” the document header 402 and the document sub-header 404. Here, content falls under a document header 402 if the content is positioned, in reading order, after the document header 402 and before a subsequent document header. Similarly, content falls under a document sub-header 404 if the content is positioned, in reading order, after the document sub-header 404 and before a subsequent document sub-header or a subsequent document header. Notably, “reading order” refers to an order in which text and other document elements are laid out in the document 114 to be read and/or consumed by a human, e.g., from left to right, and from top to bottom. In contrast to headers of a table 116 (e.g., row headers or column headers) which provide context for content within the table 116, document headers provides context for table content and non-table content falling under the document header.

Moreover, the document 114 in this example 400 includes a text block 406, e.g., detected as a natural language paragraph by the table structure detection model 204. In addition, the document 114 includes table content 408 of a first table 116a detected by the table structure detection model 204, and table content of a second table 116b detected by the table structure detection model 204. In particular, the table content of the second table 116b includes a first table content portion 410 and a second table content portion 412.

Furthermore, the document 114 includes a table caption 414 of the first table 116a, and a table caption 416 of the second table 116a. Notably, a table caption is a portion of text in the document 114 typically situated immediately after a table 116 (in reading order) that provides contextual information about the table 116 and/or summarizes findings from the table 116. In one or more implementations, the document element detection model 202 includes functionality for detecting table captions based on one or more text-based indicators, such as a positioning of the table captions relative to corresponding tables and/or font characteristics of the table captions. Here, for example, the document element detection model 202 detects the table captions 414, 416 based on the table captions 414, 416 being positioned directly beneath the tables 116a, 116b, the font size of the table captions 414, 416 being smaller than the main body text of the document 114, and/or the table captions 414, 416 being italicized.

As shown, the document chunking module 218 receives the document 114, and generates a non-table chunk 224, and three table chunks 222a, 222b, 222c. The non-table chunk 224 includes the text block 406, the table chunk 222a includes a modified table 124a having the table content 408 of the first table 116a, the table chunk 222b includes a first portion of a modified table 124b having the first table content portion 410 of the second table 116b, and the table chunk 222c includes a second portion of the modified table 124b having the second table content portion 412 of the second table 116b.

Here, the document chunking module 218 is configured to confine the table chunks 222a, 222b, 222c to a first threshold size 418, and confine the non-table chunk 224 to a second threshold size 420, such that the first threshold size 418 is smaller than the second threshold size 420. For example, the table chunks 222a, 222b, 222c include fewer than a first threshold number of tokens (e.g., 6,000 tokens), and the non-table chunk 224 includes fewer than a second threshold number of tokens, e.g., 16,000 tokens.

Another chunking technique implemented by the document chunking module 218 includes replicating document headers to chunks that fall under the document headers, and replicating document sub-headers to chunks that fall under the document sub-headers. As shown, the content of the document 114 in each of the chunks 224, 222a, 222b, 222c falls under the document header 402, e.g., the text block 406, the table content 408, the first table content portion 410, and the second table content portion 412. Therefore, the document header 402 is included in the non-table chunk 224 and the table chunks 222a, 222b, 222c. In addition, content of the table chunks 222b, 222c falls under the document sub-header 404, e.g., the first table content portion 410, and the second table content portion 412. Therefore, the table chunks 222b, 222c additionally include the document sub-header 404.

Although one document header and one document sub-header are shown in the illustrated example 400, it is to be appreciated that the described chunking techniques are applicable to multiple layers of document sub-headers. For example, a document 114 includes a document header, a first layer of document sub-headers that fall under the document header, a second layer of document sub-headers that fall under a particular document sub-header in the first layer, and so on. Given this, the document header is replicated to chunks representing content that falls under the first layer of document sub-headers and the second layer of document sub-headers. In addition, the particular document sub-header is replicated to chunks representing content that falls under the second layer of document sub-headers.

In addition, when table captions are detected by the document element detection model 202, the document chunking module 218 is configured to add the table captions to corresponding table chunks 222. Here, for example, the table caption 414 of the first table 116a is added to the table chunk 222a that includes the table content 408 of the first table 116a, as shown. In addition, in scenarios in which the modified table 124 is split into multiple table chunks 222, the document chunking module 218 is configured to replicate the table caption of the modified table 124 to the multiple table chunks 222. Here, for example, the table caption 416 of the second table 116b is replicated to the table chunks 222b, 222c that include the table content of the second table 116b.

In one or more implementations, the document chunking module 218 is configured to replicate a predefined amount of textual content occurring before a table 116 (e.g., in reading order) in the document 114 to a table chunk 222 representing the table 116. More specifically, the document chunking module 218 is configured to replicate a predefined amount of long form textual content to the table chunk 222. In accordance with the described techniques, long form textual content refers to natural language paragraphs detected by the document element detection model 202, as opposed to other document elements, e.g., document headers, document sub-headers, tables, images, table captions, figures, lists, and so on.

In the illustrated example 400, the predefined amount of textual content is two sentences. Given this, the document chunking module 218 adds previous text 422 (e.g., shown in bold in the illustrated example) to the table chunk 222a. This is because the previous text 422 corresponds to the two sentences of long form textual content that immediately precede the first table 116a represented by the table chunk 222a. In addition, the previous text 422 is additionally added to the table chunks 222b, 222c, as shown. This is because the previous text 422 corresponds to the two sentences of long form textual content that immediately precede the second table 116b represented by the table chunks 222b, 222c. Further, in scenarios in which the document chunking module 218 splits table content into multiple table chunks 222, the document chunking module 218 is configured to replicate the previous text 422 to the multiple table chunks 222. Thus, in the example 400, the previous text 422 is replicated to both the table chunks 222b, 222c representing the table content of the second table 116b.

Notably, other forms of textual content (e.g., the document sub-header 404 and the table caption 414) come after the previous text 422 and before the second table 116b, e.g., in reading order. However, these portions of text are not added to the table chunks 222b, 222c as the previous text 422 because these portions of text are not detected as natural language paragraphs by the document element detection model 202.

Another chunking strategy implemented by the document chunking module 218 includes avoiding splitting a modified table 124 into multiple table chunks 222 if the modified table 124 is capable of fitting within a single table chunk 222. In examples in which the threshold size 418 for table chunks 222 is 6,000 tokens, for instance, the document chunking module 218 is configured to maintain a modified table 124 within a single table chunk 222 if the single table chunk 222 having the modified table 124 (as well as various non-table data that is pertinent to the modified table 124) includes fewer than 6,000 tokens. In the illustrated example 400, there is less than 6,000 tokens in the modified table 124a, the document header 402, the table caption 414, and the previous text 422, and therefore, the modified table 124 is maintained in a single table chunk 222a.

In contrast, there is more than 6,000 tokens in the modified table 124b, the document header 402, the document sub-header 404, the table caption 416, and the previous text 422. Therefore, the document chunking module 218 splits the modified table 124b into a first table chunk 222b having the first table content portion 410 and a second table chunk 222c having the second table content portion 412. Further, the document chunking module 218 replicates the document header 402, the document sub-header 404, the table caption 416, and the previous text 422 to both table chunks 222b, 222c, as shown.

In one or more implementations, the document chunking module 218 is configured to split the document 114 into the plurality of chunks based on the presence of document headers and document sub-headers. For example, in a first stage of chunking, the document chunking module 218 initially splits the document 114 into a first plurality of chunks based on the presence of document headers, e.g., so that each chunk in the first plurality of chunks includes the content falling under a different respective document header. Next, the document chunking module 218 identifies chunks in the first plurality of chunks that are too large, e.g., table chunks 222 that exceed the first threshold size 418 and non-table chunks 224 that exceed the second threshold size 420. Further, in a second stage of chunking, the document chunking module 218 further splits the identified chunks into a second plurality of chunks based on the presence of document sub-headers, e.g., so that each chunk in the second plurality of chunks includes the content falling under a different respective document sub-header.

After the second stage of chunking, the document chunking module 218 identifies chunks in the second plurality of chunks that are too large, e.g., table chunks 222 that exceed the first threshold size 418 and non-table chunks 224 that exceed the second threshold size 420. Further, in a third stage of chunking, the document chunking module 218 further splits the identified chunks into a third plurality of chunks based on the presence of tables and/or a predetermined number of line breaks. Consider an example in which the predetermined number of line breaks is four. In this example, the beginning of each table marks the beginning of a new chunk, and every four line breaks marks the beginning of a new chunk. Accordingly, the document chunking module 218 traverses the identified chunks in reading order, splitting the identified chunks at every table encountered, and/or after every fourth line break encountered.

After the third stage of chunking, the document chunking module 218 is configured to merge together chunks in the third plurality of chunks based on the threshold sizes 418, 420. For example, the document chunking module 218 merges together consecutive chunks in the third plurality of chunks to form a merged chunk until merging a next consecutive chunk pushes the merged chunk above the threshold size 418 (if the merged chunk includes at least one modified table 124) or the threshold size 420 (if the merged chunk does not include any modified tables 124). In one or more examples, non-table content of a respective merged table chunk 222 is moved to a previous chunk and/or a next consecutive chunk to ensure that the merged table chunk is maintained in a single chunk that is smaller than the threshold size 418.

As previously mentioned, the various table-specific chunking techniques discussed herein improve answer accuracy and relevancy with respect to answering table-specific prompts. For example, LLMs often fail to identify an answer to a prompt when the answer is present in a table within a relatively large document chunk. This scenario is commonly referred to as the “lost in the middle” phenomenon. By incorporating tables into smaller document chunks than non-tables, the prompt answering model 122 is able to focus on the table data in a more localized manner. This reduces “lost in the middle” scenarios, thereby improving answer accuracy and relevancy with respect to table-specific prompts.

Various other table-specific chunking techniques are implemented to retain context across different document chunks. For example, by avoiding splitting a modified table 124 into multiple chunks when it is possible (based on the threshold size 418) to maintain the modified table 124 in a single chunk, the single chunk retains the context provided by other rows of the modified table 124. Moreover, the described techniques enable each respective chunk 220 to retain the context of the document header and/or document sub-header that is applicable to the respective chunk by replicating the document headers and sub-headers in the manner described. Similarly, in scenarios in which a modified table 124 is split into multiple chunks, replicating the non-table data that is pertinent to the modified table 124 (e.g., the document header, the document sub-header, the table caption, and/or long form text immediately preceding the modified table 124) enables each of the multiple chunks to retain the context of the pertinent non-table data.

Returning to FIG. 2, the plurality of chunks 220 are provided as input to the prompt answering model 122, along with the prompt 118 and an instruction 226. In one or more implementations, the instruction 226 includes text instructing the prompt answering model 122 how to answer the prompt 118. For instance, the instruction 226 includes table-specific directions defining how the prompt answering model 122 is to identify, process, and extract information from the modified table 124, and how to formulate an answer 126 that relies on information in the modified table 124. In other words, the instruction 226 provides additional guidelines for the prompt answering model 122 to follow when generating answers 126 to prompts 118 that use and/or rely on tabular data.

By way of example, the instruction 226 includes an indication that one or more tables are included in the document 114, e.g., “the document may contain paragraphs, lists, and/or tables.” Since the modified tables 124 are encoded in a different format (e.g., HTML) than non-table content, the instruction 226 also includes an indication of a format of the modified table 124 in some examples, e.g., “the tables will be encoded in HTML format.” This enables the prompt answering model 122 to quickly distinguish between tabular data and other forms of textual content, e.g., natural language content.

In one or more implementations, the instruction 226 includes a guideline to use logic and arithmetic to answer the prompt 118, e.g., “an arithmetic and logical approach will help to quickly arrive at the solution to this problem.” Additionally or alternatively, the instruction 226 includes a guideline to use chain of thought reasoning in crafting the answer 126, directing the prompt answering model 122 to explain step by step how the answer 126 was formulated, e.g., “when generating an answer from a table, break down your answer and provide reasoning about how you arrived at the answer” and/or “think step by step and explain your answer if that will help better understand the answer.” In experimental analysis, these table-specific directions and/or guidelines have demonstrated improved answer accuracy and relevancy for table-specific prompts 118.

In one or more implementations, the prompt answering model 122 receives the plurality of chunks 220, the prompt 118, and the instruction 226 as input, which causes the prompt answering model 122 to output an answer 126 to the prompt 118. In various implementation scenarios, outputting the answer 126 to the prompt 118 includes presenting the answer 126 in a user interface 106 As previously mentioned, the prompt answering model 122 is a machine learning model (e.g., an LLM) that has been pre-trained to perform a variety of natural language processing tasks, including question/prompt answering. Examples of the prompt answering model 122 include generative pre-trained transformer (GPT) models, bidirectional encoder representations from transformers (BERT) models, robustly optimized BERT approach (RoBERTa) models, and text-to-text transfer transformer (T5) models, to name just a few.

In one or more implementations, the prompt answering model 122 is refined using few shot learning for the task of generating answers to table-specific prompts 118. In general, few shot learning is characterized by using a small number of labeled training samples (e.g., few shot examples) to train a machine learning model, as opposed to other training approaches that use a much larger number of training samples. In accordance with the described techniques, the few shot examples are provided to the prompt answering model 122 as part of the instruction 226. In addition, the few shot examples each include a training document (having been chunked in accordance with the described techniques) that includes one or training tables (having been modified in accordance with the described techniques), a table-specific training prompt, and a training answer that relies on information from the one or more training tables. In one or more examples, the training answer demonstrates how the prompt answering model 122 is to perform the various table-specific directions mentioned above, e.g., the training answer includes the use of logic, arithmetic, and chain of thought reasoning.

In particular, the prompt answering model 122 generates predicted answers to the training prompts of the few shot examples, in part, by extracting information from the one or more training tables. Furthermore, the predicted answers are compared to corresponding training answers to generate a loss, e.g., using a loss function. To determine a loss between a predicted answer and a training answer, for example, the predicted answer and the generated answer are encoded (e.g., as vectors) in a common embedding space that captures semantic meaning. Any one or more of a plurality of public or proprietary embedding models are usable to encode the predicted answer and the generated answer, such as a Sentence-BERT (SBERT) model, a Word2Vec model, a Global Vectors for Word Representation (GloVe) model, or Universal Sentence Encoder (USE) model, and so on. The loss captures a distance (e.g., Euclidean distance) between a vector representative of the predicted answer and a vector representative of the training answer. After the loss is determined, parameters (e.g., internal weights) of the prompt answering model 122 are updated to reduce the loss. This process is repeated on each of the few shot examples, thereby refining the prompt answering model 122 for generating answers to table-specific prompts 118.

In addition or as an alternative to the few shot learning approach in which the few shot examples are provided to the prompt answering model 122 as part of the instruction 226 during an inference phase, the prompt answering model 122 is refined during a pre-inference training phase using supervised learning. This approach involves refining the prompt answering model 122 during a training phase based on labeled training data, and thereafter, deploying the refined prompt answering model 122 to generate an answer 126 to an unseen prompt 118. In particular, the prompt answering model 122 receives training data including a plurality of training samples. Like the few shot examples, the training samples each include a training document (having been chunked in accordance with the described techniques) that includes one or training tables (having been modified in accordance with the described techniques), a table-specific training prompt, and a training answer that relies on information in the one or more training tables. Here, the prompt answering model 122 learns to generate answers to table-specific prompts based on the training samples similarly to the few shot learning approach, while using a larger number of training samples during a pre-inference training phase.

In one or more implementations, the prompt answering model 122 generates an answer 126 to the prompt 118 based on the plurality of chunks 220, the prompt 118, and the instruction 226. In examples in which the prompt 118 is table-specific, the prompt answering model 122 generates the answer 126, in part, by extracting information from the modified table 124. In one or more implementations, the prompt answering model 122 individually processes and analyzes each of the chunks 220 to generate the answer 126. Additionally or alternatively, the prompt answering pipeline 112 encodes the chunks 220 as embeddings (e.g., vectors) using an embedding model, retrieves embeddings that are relevant to the prompt 118, and generates the answer 126 by extracting information from portions of the document 114 corresponding to the retrieved embeddings, as further discussed below with reference to

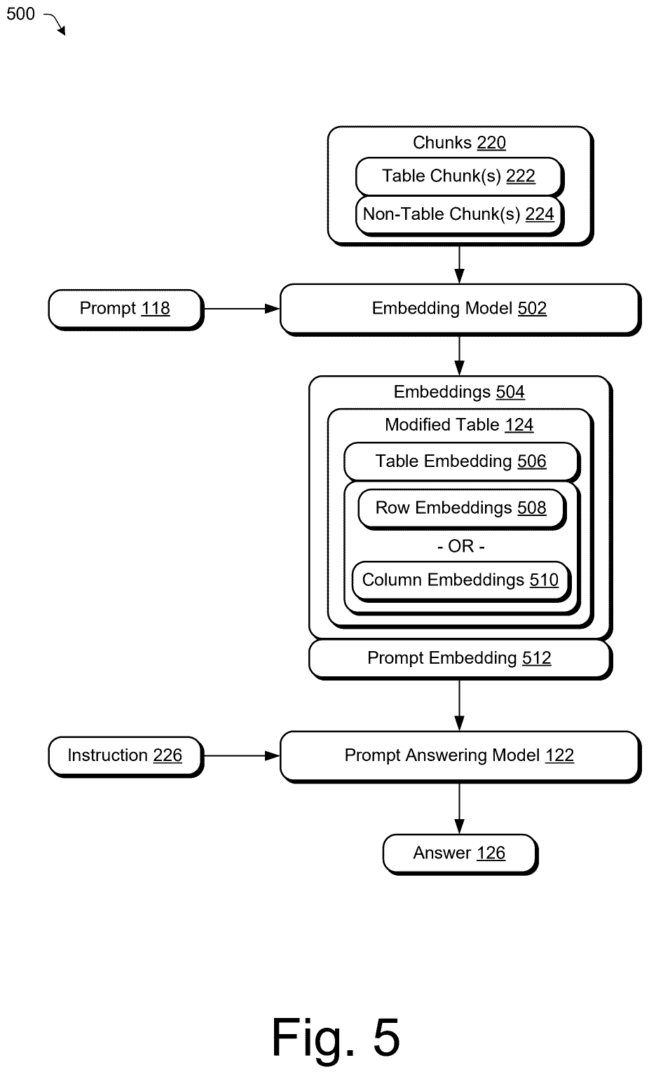

FIG. 5 depicts a system 500 in an example implementation showing operation of an embedding model to index a plurality of chunks of a document as a plurality of embeddings for prompt answering. As shown, the plurality of chunks 220 are provided as input to an embedding model 502, which is a machine learning model that has been pre-trained to encode tabular data and non-tabular data (e.g., natural language text) in a common embedding space. Any one or more of a variety of plurality of public or proprietary embedding models are usable by the prompt answering pipeline 112, examples of which include a TabTransformer model, a Table-based Pretraining for Answer Sentence Selection (TAPAS) model, and a TabNet model.

Here, the embedding model 502 generates a plurality of embeddings 504 by encoding the chunks 220, thereby representing the chunks 220 numerically as vectors in the common embedding space of the embedding model 502. In particular, the embedding model 502 generates a table embedding 506 of the modified table 124. In addition, the embedding model 502 generates multiple row embeddings 508 of individual rows of the modified table 124, or multiple column embeddings 510 of individual columns of the modified table 124. In other words, the embedding model 502 processes table chunks 222 by generating separate embeddings for each modified table 124 in the document 114. Moreover, the embedding model 502 generates separate embeddings for each individual row of a modified table 124 in the document 114 or for each individual column of the modified table 124 in the document 114.

In addition, the embedding model 502 is configured to generate a prompt embedding 512 from the prompt 118, thereby representing the prompt 118 numerically as a vector in the common embedding space of the embedding model 502. As shown, the embeddings 504 and the prompt embedding 512 are provided as input to the prompt answering model 122 along with the prompt 118 and the instruction 226. Rather than processing each individual chunk 220, the prompt answering model 122 is configured to retrieve embeddings 504 that are relevant to the prompt 118. To do so, the prompt answering model 122 computes a distance (e.g., Euclidean distance) between each embedding 504 and the prompt embedding 512. Further, the prompt answering model 122 retrieves, as the relevant embeddings 504, the embeddings 504 that are less than a threshold distance from the prompt embedding 512.

Given this, the prompt answering model 122 generates the answer 126 by extracting information from the portions of the document 114 corresponding to the retrieved embeddings 504. In examples in which the relevant embeddings 504 include the table embedding 504, the prompt answering model 122 extracts information from the modified table 124 as a whole. In examples in which the relevant embeddings 504 include a row embedding 508 or a column embedding 510, the prompt answering model 122 extracts information from an individual row or an individual column of the modified table 124.

In one or more implementations, the prompt answering pipeline 112 is leveraged for the task of answer attribution, which involves attributing the answer 126 (or portions thereof) to corresponding portions of evidence (e.g., tables, sentences, figures, images, etc.) in the document 114. The generation and retrieval of row embeddings 508 or column embeddings 510 improves answer attribution because the prompt answering pipeline 112 is able to attribute the answer 126 (or portions thereof) to finer granularity portions of the table 116, e.g., specific row(s) or specific column(s) of the table 116 rather than the table 116 as a whole.

Moreover, by generating the table embedding 506 in addition to the row embeddings 508 or the column embeddings 510 in the described manner, the prompt answering model 122 improves table retrieval success rate. Broadly, table retrieval success rate is a rate at which the prompt answering model 122 successfully retrieves one or more embeddings 504 representing the modified table 124 when the prompt 118 is table-specific. For example, when a table embedding 506 is unable to be retrieved due to a lack of specificity in representing the underlying data, the prompt answering model 122 is often able to retrieve one or more row embeddings 508 or one or more column embeddings 510 of the modified table 124 that represent the table data with increased specificity. Similarly, in scenarios in which the row embeddings 508 or the table embeddings 506 are unable to be retrieved due to a lack of contextual information in representing the underlying data, the prompt answering model 122 is often able to retrieve the table embedding 506 of the modified table 124 that represents the table data with increased contextual information.

Although examples are described herein in which the embedding model 502 generates row embeddings 508 or column embeddings 510 of the modified table 124, these examples are not to be construed as limiting. Instead, it is to be appreciated that the embedding model 502 generates row embeddings 508 and column embeddings 510 of the modified table 124, and the prompt answering model 122 retrieves one or more relevant row embeddings 508 and one or more relevant column embeddings 510 in variations.

### Example Procedures

The following discussion describes techniques that are implementable utilizing the previously described systems and devices. Aspects of each of the procedures are implemented in hardware, firmware, software, or a combination thereof. The procedures are shown as a set of blocks that specify operations performed by one or more devices and are not necessarily limited to the orders shown for performing the operations by the respective blocks.

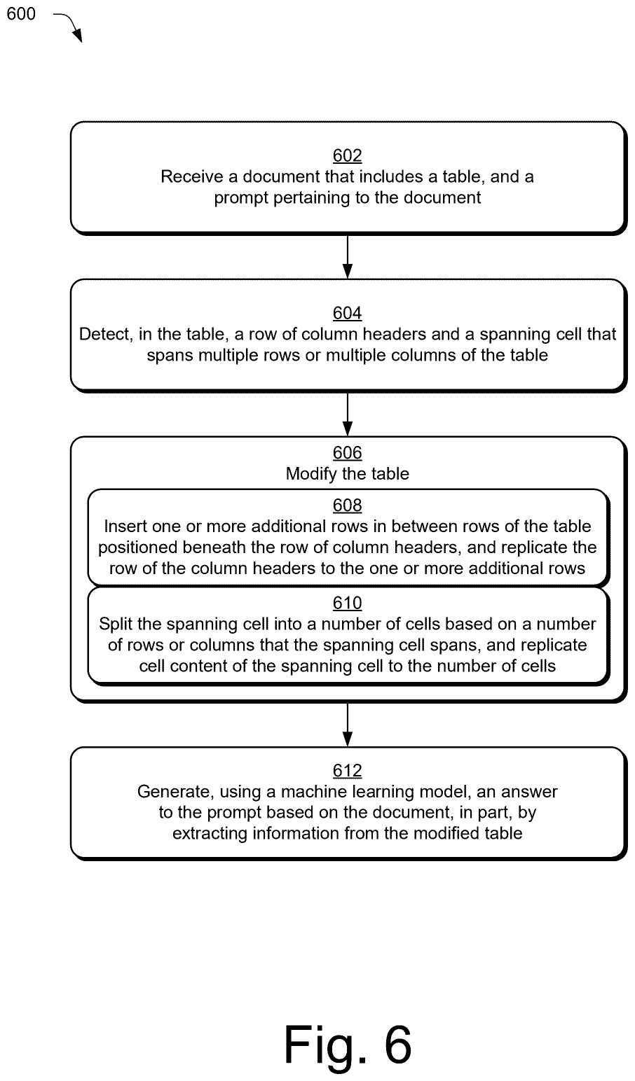

FIG. 6 is a flow diagram depicting a procedure 600 in an example implementation for processing tables in documents for prompt answering. As shown, a document is received that includes a table, and a prompt pertaining to the document (block 602). For instance, the prompt answering pipeline 112 receives the document 114 having the table 116, and a prompt 118 that pertains to the document 114. For example, the prompt 118 is a question pertaining to the table 116 in that accurately answering the question involves extracting, summarizing, and/or synthesizing information from the table 116.

A row of column headers and a spanning cell are detected in the table, and the spanning cell spans multiple rows or multiple columns of the table (block 604). For example, the table structure detection model 204 detects the row of column headers 206 and the spanning cell 208. The row of column headers 206 is a row detected by the table structure detection model 204 in which all cells in the row (or at least a threshold percentage of cells in the row) are detected as column headers by the table structure detection model 204. The spanning cell 208 is a cell that spans multiple columns and/or multiple rows in the table 116.

The table is modified (block 606). As part of this, one or more additional rows are inserted in between rows of the table positioned beneath the row of column headers, and the row of column headers is replicated to the one or more additional rows (block 608). For example, the table modification module 120 is configured to modify the table 116 to generate a modified table 124. In particular, the table modification module 120 inserts one or more additional rows 214 in between rows of the table 116 that are positioned beneath the row of column headers 206 in the table 116. In addition, the table modification module 120 replicates the cell content 210 of the row of column headers 206 to the one or more additional rows 214.

The spanning cell is split into a number of cells based on a number of rows or columns that the spanning cell spans, and cell content of the spanning cell is replicated to the number of cells (block 610). By way of example, the table modification module 120 splits the spanning cell 208 into a number of split cells 216 based on a number of rows and columns that the spanning cell 208 spans. More specifically, the number of cells is obtained by multiplying the number of rows that the spanning cell 208 spans by the number of columns that the spanning cell 208 spans. Furthermore, the table modification module 120 replicates the cell content 212 of the spanning cell 208 to the split cells 216.

An answer to the prompt is generated using a machine learning model based on the document, in part, by extracting information from the modified table (block 612). By way of example, the prompt answering model 122 receives the prompt 118 and the document 114 having the modified table 124. In one or more implementations, the document 114 is split into a plurality of chunks 220 prior to being provided to the prompt answering model 122. The prompt answering model 122 outputs an answer 126 to the prompt 118 by extracting, summarizing, and/or summarizing information from the document 114 and the modified table 124.

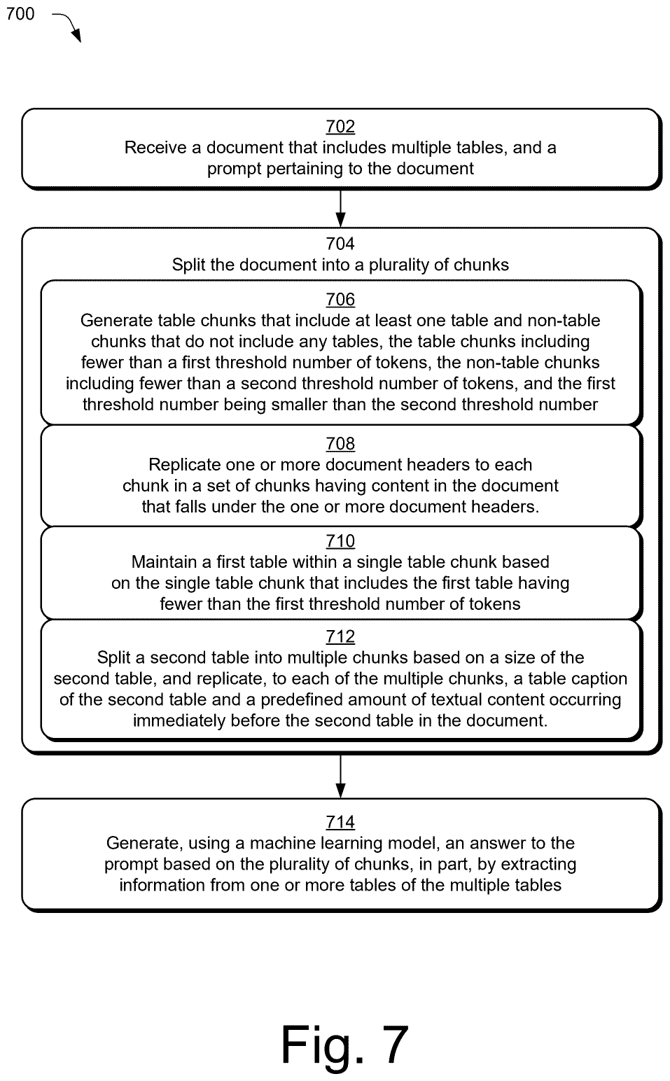

FIG. 7 is a flow diagram depicting a procedure 700 in an example implementation for processing tables in documents for prompt answering. As shown, a document is received that includes multiple tables, and a prompt pertaining to the document (block 702). For instance, the prompt answering pipeline 112 receives the document 114 having multiple tables 116, and a prompt 118 that pertains to the document 114. By way of example, the prompt 118 is a question that pertains to the table in that answering the question involves extracting, summarizing, and/or synthesizing information from one or more tables 116 of the multiple tables 116. In accordance with the described techniques, the table modification module 120 converts the tables 116 to modified tables 124.

The document is split into a plurality of chunks (block 704). As part of this, table chunks that include at least one table and non-table chunks that do not include any tables are generated, the table chunks include fewer than a first threshold number of tokens, the non-table chunks include fewer than a second threshold number of tokens, and the first threshold number is smaller than the second threshold number (block 706). For example, the document chunking module 218 generates table chunks 222 that include content of at least one modified table 124, and non-table chunks 224 that do not include table content from any modified tables 124. Here, the document chunking module 218 is configured to include fewer than a first threshold number of tokens in the table chunks 222, and fewer than a second threshold number of tokens in the non-table chunks. The first threshold number of tokens (e.g., 6,000 tokens) to be included in table chunks 222 is smaller than the second threshold of tokens (e.g., 16,000 tokens) to be included in non-table chunks 224.

One or more document headers are replicated to each chunk in a set of chunks having content in the document that falls under the one or more document headers (block 708). By way of example, the document 114 is split such that a set of chunks 220 includes content of the document 114 that falls under one or more document headers (e.g., a document header 402 and a document sub-header 404) in the document 114. Content is considered to fall under a document header if the content is after the document header (in reading order) and before a subsequent document header (in reading order). Here, the document chunking module 218 replicates the one or more document headers to each chunk 220 in the set of chunks 220.

A first table is maintained within a single table chunk based on the single table chunk that includes the first table having fewer than the first threshold number of tokens (block 710). By way of example, the document chunking module 218 is configured to avoid splitting a modified table 124 into multiple table chunks 222 if the modified table 124 is capable of fitting within a table chunk 222 that satisfies the first threshold size 418, e.g., containing fewer than 6,000 tokens. Here, a first modified table 124 (as well as non-table content to be included in a table chunk 222 representative of the first modified table 124) contains fewer than the first threshold number of tokens. As such, the document chunking module 218 maintains the first modified table 124 in a single table chunk 222.

A second table is split into multiple chunks based on a size of the second table, and a table caption as well as a predefined amount of textual content occurring immediately before the second table in the document are replicated to each of the multiple chunks (block 712). By way of example, a second modified table 124 (as well as non-table content to be included in table chunk(s) 224 representative of the second modified table 124) contain more than the first threshold number of tokens. As such, the document chunking module 218 splits the second modified table 124 into multiple table chunks 222. In addition, the document chunking module 218 replicates non-table content that is pertinent to the second modified table 124 to each of the multiple table chunks 222. This non-table content includes a table caption of the second modified table 124 and a predefined amount of long form textual content occurring immediately before the second modified table 124 (in reading order) in the document 114.

An answer to the prompt is generated using a machine learning model based on the plurality of chunks, in part, by extracting information from one or more tables of the multiple tables (block 714). By way of example, the prompt answering model 122 receives the prompt 118, and the plurality of chunks 220. In one or more implementations, the prompt answering model 122 generates the answer 126 by individually processing and analyzing each of the chunks 220. Additionally or alternatively, the embedding model 502 generates a prompt embedding 512 of the prompt 118 as well as embeddings 504 of the plurality of chunks 220. Furthermore, the prompt answering model 122 retrieves embeddings 504 that are relevant to the prompt 118 based on similarities between the embeddings 504 and the prompt embedding 512, and generates the answer 126 by extracting information from portions of the document 114 corresponding to the retrieved embeddings 504. In implementations, the answer generation process involves extracting, summarizing, and/or summarizing information from the document 114 and the modified table 124.

### Example System and Device

FIG. 8 illustrates an example system generally at 800 that includes an example computing device 802 that is representative of one or more computing systems and/or devices that implement the various techniques described herein. This is illustrated through inclusion of the prompt answering pipeline 112. The computing device 802 is configurable, for example, as a server of a service provider, a device associated with a client (e.g., a client device), an on-chip system, and/or any other suitable computing device or computing system.

The example computing device 802 as illustrated includes a processing system 804, one or more computer-readable media 806, and one or more I/O interface 808 that are communicatively coupled, one to another. Although not shown, the computing device 802 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 804 is representative of functionality to perform one or more operations using hardware. Accordingly, the processing system 804 is illustrated as including hardware element 810 that is configurable as processors, functional blocks, and so forth. This includes implementation in hardware as an application specific integrated circuit or other logic device formed using one or more semiconductors. The hardware elements 810 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 806 is illustrated as including memory/storage 812. The memory/storage 812 represents memory/storage capacity associated with one or more computer-readable media. The memory/storage 812 includes volatile media (such as random access memory (RAM)) and/or nonvolatile media (such as read only memory (ROM), Flash memory, optical disks, magnetic disks, and so forth). The memory/storage 812 includes fixed media (e.g., RAM, ROM, a fixed hard drive, and so on) as well as removable media (e.g., Flash memory, a removable hard drive, an optical disc, and so forth). The computer-readable media 806 is configurable in a variety of other ways as further described below.

Input/output interface(s) 808 are representative of functionality to allow a user to enter commands and information to computing device 802, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 802 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” “component,” and “system” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 802. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 802, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 810 and computer-readable media 806 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also employed to implement various techniques described herein. Accordingly, software, hardware, or executable modules are implemented as one or more instructions and/or logic embodied on some form of computer-readable storage media and/or by one or more hardware elements 810. The computing device 802 is configured to implement particular instructions and/or functions corresponding to the software and/or hardware modules. Accordingly, implementation of a module that is executable by the computing device 802 as software is achieved at least partially in hardware, e.g., through use of computer-readable storage media and/or hardware elements 810 of the processing system 804. The instructions and/or functions are executable/operable by one or more articles of manufacture (for example, one or more computing devices 802 and/or processing systems 804) to implement techniques, modules, and examples described herein.

The techniques described herein are supported by various configurations of the computing device 802 and are not limited to the specific examples of the techniques described herein. This functionality is also implementable all or in part through use of a distributed system, such as over a “cloud” 814 via a platform 816 as described below.

The cloud 814 includes and/or is representative of a platform 816 for resources 818. The platform 816 abstracts underlying functionality of hardware (e.g., servers) and software resources of the cloud 814. The resources 818 include applications and/or data that can be utilized while computer processing is executed on servers that are remote from the computing device 802. Resources 818 can also include services provided over the Internet and/or through a subscriber network, such as a cellular or Wi-Fi network.

The platform 816 abstracts resources and functions to connect the computing device 802 with other computing devices. The platform 816 also serves to abstract scaling of resources to provide a corresponding level of scale to encountered demand for the resources 818 that are implemented via the platform 816. Accordingly, in an interconnected device embodiment, implementation of functionality described herein is distributable throughout the system 800. For example, the functionality is implementable in part on the computing device 802 as well as via the platform 816 that abstracts the functionality of the cloud 814.

What is claimed is:

1. A method comprising:
receiving, by a processing device, a document that includes a table, and a prompt pertaining to the document;
detecting, by the processing device and in the table, a row of column headers and a spanning cell that spans multiple rows or multiple columns of the table;
modifying, by the processing device, the table by inserting additional cells in the table and replicating cell content of the row of column headers and the spanning cell to the additional cells, resulting in a modified table; and
generating, by the processing device and using a machine learning model, an answer to the prompt based on the document, in part, by extracting information from the modified table.

2. The method of claim 1, wherein modifying the table includes encoding the table in a format that differs from other elements of the document, the other elements including one or more of paragraphs, images, figures, lists, footnotes, and document headings.

3. The method of claim 1, wherein inserting the additional cells includes inserting one or more additional rows in between rows of the table positioned beneath the row of column headers, and replicating the cell content includes replicating the cell content of the row of column headers to the one or more additional rows.

4. The method of claim 1, wherein inserting the additional cells includes splitting the spanning cell into a number of cells based on a number of rows or columns that the spanning cell spans, and replicating the cell content includes replicating the cell content of the spanning cell to the number of cells.

5. The method of claim 1, further comprising splitting, by the processing device, the document having the modified table into a plurality of chunks, wherein generating the answer includes providing the plurality of chunks as input to the machine learning model.

6. The method of claim 5, wherein splitting the document includes generating one or more table chunks that include content of the modified table and one or more non-table chunks that exclude content of the modified table, the one or more table chunks including fewer than a first threshold number of tokens, the one or more non-table chunks including fewer than a second threshold number of tokens, and the first threshold number being smaller than the second threshold number.

7. The method of claim 5, wherein splitting the document includes maintaining the modified table within a single chunk based on the single chunk that includes the modified table being smaller than a threshold size.

8. The method of claim 5, wherein the plurality of chunks includes a set of chunks having content in the document that falls under one or more document headers, and splitting the document includes replicating the one or more document headers to each chunk in the set of chunks.

9. The method of claim 5, wherein splitting the document includes splitting the modified table into multiple chunks based on a size of the modified table, and replicating, to each of the multiple chunks, a table caption of the modified table and a predefined amount of textual content occurring before the table in the document.

10. The method of claim 1, wherein generating the answer includes providing, as input to the machine learning model, the document having the modified table, the prompt, and an instruction, wherein the instruction includes one or more of: an indication that one or more tables are included in the document, an indication of a format of the one or more tables, a guideline to use logic and arithmetic to answer the prompt, and a guideline to use chain of thought reasoning in crafting the answer.

11. The method of claim 1, further comprising generating, using a machine learning embedding model, a plurality of embeddings based on the document, the plurality of embeddings including an embedding of the modified table and multiple embeddings of individual rows of the modified table or individual columns of the modified table, wherein generating the answer includes retrieving one or more embeddings of the plurality of embeddings that are relevant to the prompt, and extracting the information from portions of the modified table corresponding to the one or more embeddings.

12. A system comprising:
a processing device; and
a memory storing instructions that are executable by the processing device to perform operations including:
receiving a document that includes a table, and a question pertaining to the document;
detecting a row of column headers in the table;
modifying the table by inserting one or more additional rows in between rows of the table positioned beneath the row of column headers, and replicating the row of column headers to the one or more additional rows, resulting in a modified table; and
generating, using a machine learning model, an answer to the question based on the document, in part, by extracting information from the modified table.

13. The system of claim 12, further comprising splitting, by the processing device, the document having the modified table into a plurality of chunks, wherein generating the answer includes providing the plurality of chunks as input to the machine learning model.

14. The system of claim 13, wherein splitting the document includes generating one or more table chunks that include content of the modified table and one or more non-table chunks that exclude content of the modified table, the one or more table chunks including fewer than a first threshold number of tokens, the one or more non-table chunks including fewer than a second threshold number of tokens, and the first threshold number being smaller than the second threshold number.

15. The system of claim 13, wherein splitting the document includes maintaining the modified table within a single chunk based on the single chunk that includes the modified table being smaller than a threshold size.

16. The system of claim 13, wherein the plurality of chunks includes a set of chunks having content in the document that falls under one or more document headers, and splitting the document includes replicating the one or more document headers to each chunk in the set of chunks.

17. The system of claim 13, wherein splitting the document includes splitting the modified table into multiple chunks based on a size of the modified table, and replicating, to each of the multiple chunks, a table caption of the modified table and a predefined amount of textual content occurring before the table in the document.

18. A non-transitory computer-readable medium storing executable instructions, which when executed by a processing device, cause the processing device to perform operations comprising:
receiving, by a prompt answering pipeline, a document that includes a table, and a prompt pertaining to the document;
splitting, by a document chunking module of the prompt answering pipeline, the table into one or more table chunks that include content of the table based on a first threshold size;
splitting, by the document chunking module of the prompt answering pipeline, the document into one or more non-table chunks that exclude the content of the table based on a second threshold size that is larger than the first threshold size; and
generating, by a machine learning model of the prompt answering pipeline, an answer to the prompt, in part, by processing the one or more table chunks and the one or more non-table chunks.

19. The non-transitory computer-readable medium of claim 18, the operations further comprising:
detecting, by an additional machine learning model of the prompt answering pipeline, a column of row headers;
modifying, by a table modification module of the prompt answering pipeline, the table by inserting one or more columns in between columns positioned laterally with respect to the column of row headers, and replicating the column of row headers to the one or more columns; and
generating, by the machine learning model of the prompt answering pipeline, the answer to the prompt, in part, by processing the one or more table chunks including the modified table.

20. The non-transitory computer-readable medium of claim 18, the operations further comprising:
detecting, by an additional machine learning model of the prompt answering pipeline, a spanning cell that spans multiple rows or multiple columns;
modifying, by a table modification module of the prompt answering pipeline, the table by splitting the spanning cell into a number of cells, and replicating cell content of the spanning cell to the number of cells; and
generating, by the machine learning model of the prompt answering pipeline, the answer to the prompt, in part, by processing the one or more table chunks including the modified table.
